(19) United States
(12) Patent Application Publication
(10) Pub. No.: US 2026/0295441 A1
(43) Pub. Date: Oct. 1, 2026

(54) COMPUTER-IMPLEMENTED FANTASY SPORTS PLATFORM

(71) Applicants: Christopher Thomas, San Marcos, CA (US); Shane Blackburn, San Marcos, CA (US)

(72) Inventors: Christopher Thomas, San Marcos, CA (US); Shane Blackburn, San Marcos, CA (US)

(21) Appl. No.: 19/093,290

(22) Filed: Mar. 28, 2025

(51) Int. Cl. A63F 13/828; A63F 13/35

(52) U.S. Cl. CPC A63F 13/828; A63F 13/35

(57) ABSTRACT

The present invention provides a computer-implemented method of virtualizing a fantasy sports system, a method for managing the fantasy sports platform using a computing system, and a system for managing the fantasy sports platform. The present invention advances the utility of fantasy sports platforms, scoring systems, and secure reward transferring by providing an all-in-one fantasy challenge platform with an adaptive scoring system, a secure money transfer system with virtual currency implementations, and VR and AR engagement.

### BACKGROUND OF THE INVENTION

### 1. Field of Invention

The invention relates to fantasy sports platforms, scoring systems, and secure reward transferring methods.

### 2. Description of Related Art

Fantasy sports allow participants to create a virtual team of athletes and earn points based on the athletes' performances and the participants' analysis to assemble the team of athletes. Their chosen real-world athletes determine each participant's score to complete the goal of accumulating the most points over a set amount of time. Fantasy sports leagues are contests of skill where participants must consider a myriad of statistics, facts, and game theory to be competitive in the league. Participants must know more than simple depth charts and statistics to win. A participant frequently considers injuries, coaching styles, weather patterns, prospects, home and away statistics, and numerous other pieces of information to be successful. Compared to gambling, which is games of luck and chance, fantasy sports leagues routinely demonstrate that more skilled and researched participants win games more frequently than if the contests were random or highly based on chance. For example, a study from the Massachusetts Institute of Technology in 2018 found that fantasy sports inherently reward skill based on the win/loss records of thousands of fantasy sports participants over multiple seasons. As such, fantasy sports are not gambling because fantasy sports leagues require outcomes that reflect the relative knowledge and skill of the participants. Also the outcome is determined predominantly by accumulated statistical results of sporting events, which includes any non-participant's individual performances in such sporting events.

Scoring in fantasy sports typically involves assigning points to athletes based on their real-world performance. For example, each athlete on a participant's team earns points based on their performance in actual games. Points are typically cumulative over the course of a season, with participants competing against each other for the highest total score. Participants usually pay an upfront fee to enter the competition, game, or league and receive a payout based on their skill and analysis of choosing real-world athletes. As such, secure money-transferring systems are an important aspect of fantasy sports. Many platforms use secure payment methods such as PayPal or credit card transactions to transfer money to winners. However, current platforms have not advanced to use a combination of traditional payment methods as well as virtual currency, such as cryptocurrency and non-fungible tokens (NFT).

Advancements in mobile technology have played a significant role in the growth and popularity of fantasy sports. Online platforms and mobile applications make it easy for participants to create and manage their teams, track scores, and stay up-to-date on news and updates. Real-time scoring updates and statistical analysis also provide valuable insights for participants to make informed decisions about their team selections. Yet online platforms and mobile applications do not give users engaging or interactive content. Virtual Reality (VR) and Augmented Reality (AR) are two technologies that will make an impact in the world of fantasy sports. Yet, platforms do not have the capabilities to readily implement sought-after VR and AR features for fantasy sports to further better engagement and interactivity between participants.

Advantageously, with VR, participants experience a game or event as if they were actually there, allowing them to immerse themselves in the experience and potentially enhance their performance. AR, overlays statistics and other information onto a live game, providing participants with real-time insights and analysis that can help them make better decisions. Accordingly, it is desirable to provide a fantasy sports platform, scoring system, and a secure reward transfer, along with implementing VR and AR features.

### SUMMARY OF THE INVENTION

The present invention overcomes these and other deficiencies of the prior art by providing an all-in-one fantasy challenge platform with an adaptive scoring system, a secure money transfer system with virtual currency implementations, and VR and AR engagement. Rather than mandating participants to create individual leagues for each sport, each event, or each challenge/game, participants are presented with an all-in-one platform where all challenges are accessible. The inclusion of AR and VR components increase the engagement and interactivity of participants between each other by creating a more effective tool for communication between participants. AR and VR implementations also create a more engaging and efficient presentation where participants see real-world statistics, data, and any other relevant information about the athletes for each sporting event. These statistics and data are presented to participants, while a participant watches the sporting event or in a group watch room with other participants. Having the data at users' fingertips in real-time and in a more engaging fashion aids fantasy sports participants in making a better-informed decision on which athlete to choose.

In addition to presenting participants with an efficient and more engaging platform, an adaptive scoring system offers participants more ways to win rewards by including mini skill challenges along with the main skill challenge, all corresponding to a real-world sporting event.

The secure reward transfer feature enables participants to be rewarded and to pay funds via cryptocurrency or NFTs. NFTs will be valued on the platform's marketplace, corresponding to a sporting event. Cryptocurrency advantageously creates easy transactions at a low cost in a private manner, is secure because blockchain security is used, there are short settlement times, exponential industry growth, and the possibility of outsized returns.

In an embodiment of the present invention, a fantasy sports platform comprises an adaptive scoring system used to determine a winner of a fantasy sports challenge. The scoring system comprises specified percentages based on the number of participants and total available points. The scoring system automatically adapts to an increased or decreased number of participants and provides participants with options to participate in mini skill challenges for further winning potential.

In another embodiment of the present invention, a fantasy sports platform comprises an adaptive scoring system and a secure method of transferring funds via virtual currencies such as cryptocurrency and NFTs. The cryptocurrency and/or NFTs are transferred to a participant that wins the main skill challenge or mini skill challenges in a private and secure manner.

In another embodiment of the present invention, a fantasy sports platform comprises an adaptive scoring system, a secure method of transferring payments, and AR and VR implementations. The AR and VR features are presented to participants who can view real-time statistics and data to make an informed decision on which athlete to choose.

In an embodiment of the present invention, a computer-implemented method of presenting a fantasy sports event comprises the steps of creating a plurality of scoring categories associated with a sporting event, assigning a percentage of points to each scoring category, collecting, in real-time athlete statistical data corresponding to said sporting event from a database, presenting a participant with a Graphical User Interface to choose an athlete participating in said sporting event; recording, in real-time the athlete's performance in said sporting event; displaying to the participant real-time athlete statistical data; translating the athlete's performance corresponding to the plurality of scoring categories in the sporting event into points associated with said assigned percentages; calculating the total amount of points associated with an athlete's performance; transforming the total amount of points associated with an athlete's performance into rewards; and distributing rewards to a participant, via a secure transfer.

In an embodiment of the present invention, a computer-implemented method for scoring fantasy sports events, the method comprising the steps of: creating a point value that corresponds to a scoring category associated with a sporting event; setting the point value according to a predetermined input value; calculating an athlete's point values according to the set point value, wherein the step of calculating further comprises the steps of: calculating a main skill challenge point total, determining a number of participants, determining a number of points and dividing said number of points by said number of participants, thereby creating a point per participant based on the number of participants, multiplying the number of points per participant with the number of participants to achieve a total available points, dividing the total available points by a predetermined percentage of winnings, and dividing the divided total available points with each scoring category, thereby creating a points per scoring category percentage.

In another embodiment of the present invention, computer-implemented method of providing a fantasy golf platform 620, the method comprising the steps of: presenting a main skill challenge to a participant via a graphical user interface; presenting a mini skill challenge to a participant via the graphical user interface; presenting statistics in a VR and AR format to participants via the graphical user interface, wherein said statistics in VR and AR format comprise real-world athlete statistics and data; displaying a video stream of a sporting event in the background while performing the aforementioned steps; determining a winning participant from the main skill challenge and the mini skill challenge; and transferring a reward to the winning participant.

In another embodiment of the present invention, a computer-implemented method of virtualizing a fantasy sports system utilizes the steps of creating a plurality of scoring categories and associating the plurality of scoring categories with a sporting event; assigning a percentage of points to each of the plurality of scoring categories associated with the sporting event; selecting athletes participating in the sporting event and creating an athlete pool for a user to select an individual athlete from; collecting real-time athlete statistical data corresponding to the selected athletes participating in the sporting event from a database query on a network; displaying a Graphical User Interface (GUI) for choosing the individual athlete participating in the sporting event and presenting the real-time athlete statistical data; saving in real-time to a memory the individual athlete's performance data in the sporting event; processing from a data processor, the individual athlete's performance data corresponding to the plurality of scoring categories associated with the sporting event into points associated with the assigned percentage of points; calculating the total amount of points associated with the individual athlete's performance data; totaling the number of points corresponding to each individual athlete's performance data; converting the total amount of points associated with each individual athlete's performance data into a digital reward; and transferring the digital reward to a mobile device via a security protocol.

Additionally, the embodiment further uses the step of sending a push notification including an athlete's performance data in the sporting event, over a network communication protocol to the mobile device and wherein the step of transferring the digital reward to the mobile device includes transferring via a blockchain technology. In addition, the embodiment includes the step of transferring the digital reward to the mobile device includes transferring a Non-Fungible Token and wherein the step of transferring the digital reward to the mobile device includes transferring automatically, and the embodiment also includes the step of displaying a plurality of skill challenges on the GUI.

The embodiment further comprise the step of creating a scoring rule for the sporting event, including the steps of: creating a point value that corresponds to the plurality of scoring categories associated with the sporting event; setting the point value according to a predetermined input value; calculating an athlete's point values according to the set point value, wherein the step of calculating includes the steps of: determining a main skill challenge point total, determining a maximum number of participants, determining a maximum number of points and dividing the maximum number of points by the number of participants, thereby creating a point per participant ratio based on the number of participants, multiplying the number of points per participant with the number of participants to achieve a total amount of available points, dividing the total available points by a predetermined percentage of rewards, and dividing the divided total available points with each scoring category, thereby creating a points per scoring category percentage. The embodiment also includes wherein the steps are carried out in real-time during the sporting event and comprises a local program product utilizing machine learning, AI learning, or a combination thereof. The embodiment includes the step of sharing real-time athlete statistical data with a plurality of viewer devices connected via a network communication protocol.

In another embodiment, a method for managing a fantasy sports platform using a computing system, comprising the steps of: (a) receiving, by the computing system, user input, selecting a set of athletes for a fantasy sports team from a plurality of athletes participating in a real-world sporting event; (b) tracking, by the computing system, real-time performance data of the selected athletes during the real-world sporting event; (c) dynamically calculating, by the computing system, fantasy scores for each user's fantasy sports team based on the real-time performance data; (d) updating, by the computing system, the fantasy scores of each user's team based on the performance data in real-time throughout the duration of the real-world sporting event; (e) displaying, by the computing system, the updated fantasy scores to the user in a graphical interface; (f) adjusting, by the computing system, the fantasy sports team's ranking dynamically based on the real-time performance data of the selected athletes and comparing the calculated fantasy scores of all users on the platform to determine a winner based on the highest fantasy score; and (g) storing instructions on a non-transitory computer-readable medium that when executed by the computing system causes the computing system to perform the steps of (a)-(f).

The embodiment also includes the step of generating, by the computing system, a real-time leaderboard showing the rankings of all participating users based on the calculated fantasy scores and further includes the step of providing personalized fantasy sports guidance to a user, including: a) analyzing, by the computing system, historical performance data of the plurality of athletes; b) generating, by the computing system, a personalized set of recommended athletes for the user's fantasy team based on their historical performances, past performance in previous fantasy games, and predicted performance for an upcoming real-world sporting event; c) displaying, by the computing system, the recommended set of athletes to the user via an interactive interface. Also, the embodiment includes that the recommended set of athletes is adjusted in real-time based on the athletes' live performance data during the ongoing real-world sporting event.

An embodiment includes a system for managing a fantasy sports platform, comprising: (a) a data input module configured to receive user input identifying a set of athletes for a fantasy sports team from a plurality of athletes participating in a real-world sporting event; (b) a data processing module configured to track real-time performance data of the identified athletes during the real-world sporting event and dynamically calculate fantasy scores for each user's team based on the real-time performance data; (c) a score updating module configured to update the fantasy scores of each user's team in real-time throughout the sporting event based on the tracked performance data; (d) a display module configured to display the updated fantasy scores to a user via a graphical interface; and (e) a ranking module configured to adjust the user's team ranking dynamically based on the real-time performance data and the calculated fantasy scores.

The embodiment includes that wherein the data input module further comprises a user interface component configured to allow the user to drag and drop athletes into a fantasy team selection area, where the user's selections are tracked by the system. The embodiment also includes wherein the display module is further configured to provide a dynamic, interactive display showing player performance data and comparison between fantasy teams in real-time. Furthermore, the embodiment includes that wherein the data processing module includes a machine learning component that analyzes historical player performance data and predicts future performance trends to assist users in making fantasy team selections and that wherein the ranking module further adjusts rankings based on a tournament-specific scoring algorithm that incorporates the difficulty of venue and other contextual event factors. The embodiment includes the steps of: facilitating a dynamic, live fantasy sports game based on real-time athlete data, comprising: a) an athlete's performance data monitoring module configured to track performance metrics of athletes during a real-world event; b) a scoring algorithm module configured to dynamically calculate and adjust fantasy scores in real-time based on monitored athlete performance metrics; and c) a user engagement module configured to provide real-time notifications to users regarding changes to their fantasy team's ranking and performance in relation to other participants in the game.

The foregoing and other features and advantages of the invention will be apparent from the following, more particular description of the invention's preferred embodiments and the accompanying drawings.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a fantasy sports platform, according to an embodiment of the invention.

FIGS. 2A and 2B illustrate a fantasy sports scoring system, according to an embodiment of the invention.

FIG. 3 illustrates a fantasy sports sharing and group watching system, according to an embodiment of the invention.

FIG. 4 illustrates a secure money transfer system, according to an embodiment of the invention.

FIG. 5 illustrates a Graphical User Interface for selecting an athlete for fantasy sports, according to an embodiment of the invention.

FIG. 6 illustrates a Graphical User Interface for selecting an athlete for fantasy sports golf system, according to an embodiment of the invention.

FIG. 7 illustrates an optimized fantasy sports golf system, according to an embodiment of the invention

FIG. 8 illustrates a system of a fantasy sports platform utilizing a GUI, data processor and database, memory, challenges, push notifications, and rewards over a network, according to an embodiment of the invention.

### DETAILED DESCRIPTION OF PREFERRED EMBODIMENTS

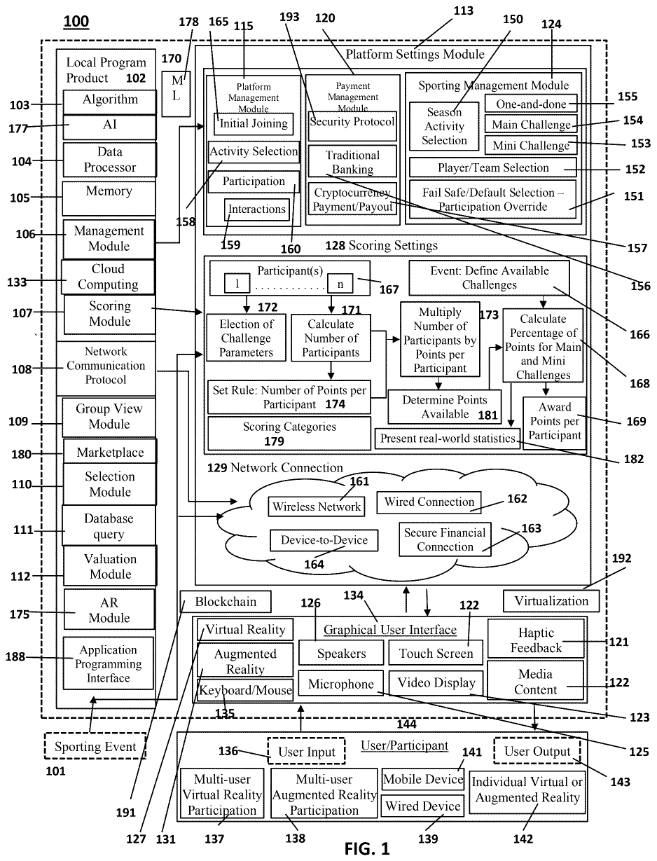

Preferred embodiments of the present invention and their advantages may be understood by referring to FIGS. 1-8, wherein like reference numerals refer to like elements. The described features, structures, or characteristics of the invention may be combined in any suitable manner in one or more embodiments. It will be apparent to those skilled in the art that various modifications and variations can be made to the present invention without departing from the invention's spirit and scope. Thus, it is intended that the current invention cover modifications and variations consistent with the scope of the appended claims and their equivalents.

The present invention advances the utility of fantasy sports platforms, scoring systems, and secure reward transferring. Rather than create multiple leagues with no engaging content and visual data, it provides a platform with AR and VR overlay displaying athlete statistics and data for participants to choose an elite athlete and win the league or sporting event. By implementing AR and VR features, the platform creates a more engaging and interactive environment which fosters higher participant satisfaction. The adaptive scoring system uses machine and AI learning to continuously update the scoring and point totals and values based on a multitude of parameters. The addition of mini skill challenges along with a main skill challenge creates more ways for participants to win funds or NFTs. By the secure money transfer system utilizing cryptocurrency and other virtual currencies, participants' payout times are decreased, payments are more private and secure, and there are lower associated costs compared to traditional forms of payment.

As used herein, a module refers to a distinct, self-contained segment of code that is designed to perform a specific function within a larger system or application. The module can be an independently executable component or a library of functions that can be utilized by other software components. For purposes of this application, a module is defined to include any combination of routines, algorithms 103, software, and data structures that interact with other modules within the system to accomplish a defined process or behavior.

An algorithm 103 is a defined, systematic sequence of computational steps that transforms input data into output results. The algorithm 103 performs a specific computational task or solves a particular problem, and it is expressed in the form of executable code, mathematical instructions, or other logically structured operations. In this invention, the algorithm 103 is distinguished by its unique approach, steps, or methodologies that improve computational efficiency, scalability, or other technical characteristics in a novel and non-obvious manner. A Data processor includes the term data processing; refers to the manipulation, transformation, or analysis of data using a sequence of operations or algorithms 103, often in real-time or batch processes. It includes activities such as the extraction, transformation, loading (ETL), aggregation, sorting, and filtering of data. In the context of this invention, data processing refers specifically to a novel technique for managing, optimizing, or interpreting data flows, wherein the claimed invention improves the efficiency or accuracy of data processing by utilizing unique methods or structures that were previously unavailable in prior art.

A user interface (UI) and graphical user interface (GUI) 134 is a collection of elements that allow interaction between a user and a computer system or software application. This includes input mechanisms such as buttons, text fields, and gesture recognition, as well as output displays, such as visual feedback or notifications. In this invention, the user interface is defined by its novel design, layout, or method of interaction that enhances user experience, simplifies task completion, or introduces a new way of presenting information that provides technical advantages over prior user interface designs.

A network communication protocol is a set of rules and conventions that govern the exchange of data between devices or systems over a network. These protocols specify the format, timing, sequencing, and error-checking procedures for data transmission. In the context of this invention, the network communication protocol is uniquely designed to address specific challenges in data transfer, such as reducing latency, improving security, or increasing throughput, providing a novel and non-obvious improvement over existing protocols. An Application Programming Interface (API) 188 is a set of rules, protocols, and tools that allow different software applications to communicate with one another. It defines the methods and data formats for requesting services or information from a system and for sending responses back. In this invention, the API 188 is distinguished by novel techniques for handling communication between software components, including features such as dynamic endpoint management, automatic version control, or enhanced security mechanisms that improve the interoperability and scalability of the overall system.

Cloud computing 133 refers to the delivery of computing services—such as servers, storage, databases, networking, software, and analytics—over the internet (the “cloud”). In this invention, cloud computing 133 is applied in a novel manner that distinguishes it from conventional approaches, whether through unique methods of resource allocation, data redundancy, task execution, or multi-tenant service provision. The invention claims a specific improvement in cloud architecture, resource management, or service delivery that enhances scalability, efficiency, or fault tolerance in ways not previously contemplated. Artificial Intelligence (AI) 177 refers to the simulation of human intelligence processes by computer systems, particularly the ability to learn, reason, and problem-solve. In this application, AI 177 is employed through a novel method or system for enhancing decision-making, prediction accuracy, or autonomous operation in software applications. The invention claims a unique approach to AI that addresses specific challenges in training models, optimizing decision trees, or managing large datasets in real-time environments, thus providing a technical improvement over existing AI techniques. Machine Learning (ML) 178 is a subset of artificial intelligence that enables systems to automatically improve their performance through experience or exposure to data, without explicit programming for each task. The invention involves a unique method or algorithm 103 for training, validating, or deploying machine learning 178 models that enhances their efficiency, accuracy, or adaptability. The claimed innovation introduces a new technique for processing training data or optimizing model parameters in a way that advances the state of the art in machine learning 178 systems.

A database query 111 is a request for information or manipulation of data from a database, typically written in a query language like SQL. The database query 111 is processed by the database management system to retrieve, insert, update, or delete data according to the request. In this invention, a novel database query 111 optimization technique is disclosed, which improves query execution speed, reduces resource consumption, or enhances data retrieval accuracy in a way that is not found in prior database management systems. Virtualization 192 refers to the creation of virtual (rather than physical) versions of resources, such as servers, storage devices, or network resources, allowing multiple virtual instances to run on a single physical system. This invention uses virtualization 192 in a unique way to improve resource management, enhance fault tolerance, or optimize the performance of virtual environments, addressing specific challenges in managing large-scale, distributed systems that prior art methods could not solve efficiently.

As used herein, the term computer 150 refers to any type of computing device including, but not limited to desktop, laptop, notebook, smartphone, workstation, tablet, and any other similar device with wireless network connectivity. The term computing device herein refers to any mobile device, such as any mobile phone, laptop, computer, tablet, iPad, Android device, iPhone, or any other telecommunication and smart devices. As such, a computing device typically houses a computer. The computer 150 has a processor 151 that performs a set of operations on information as specified by computer program code 152. The computer program code 152 is a set of instructions or statements providing instructions for the operation of the processor 151 and/or the computer system to perform specified functions. The code 152 for example, may be written in a computer programming language that is compiled into a native instruction set of the processor 151. The code 152 may also be written directly using the native instruction set (e.g., machine language). The set of operations include bringing information in from the bus 153 and placing information on the bus 153. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor 151 is represented to the processor 151 by information called instructions, such as an operation code of one or more digits. A sequence of operations to be executed by the processor, 151 such as a sequence of operation codes, constitute processor instructions, also called computer system instructions or, simply, computer instructions. Processors 151 may be implemented as mechanical, electrical, magnetic, optical, chemical or quantum components, among others, alone or in combination.

The computer 150 includes a memory 155 coupled to bus 153. The memory 155, such as a random access memory (RAM) or other dynamic storage device, stores information including processor instructions. Dynamic memory allows information stored therein to be changed by the computer 150. RAM allows a unit of information stored at a location called a memory address to be stored and retrieved independently of information at neighboring addresses. The memory 155 is also used by the processor 151 to store temporary values during execution of processor instructions. The computer 150 also includes a read only memory (ROM) or other static storage device coupled to the bus 153 for storing static information, including instructions, that is not changed by the computer 150. Some memory 155 is composed of volatile storage that loses the information stored thereon when power is lost. Also coupled to bus 153 is a non-volatile (persistent) storage device 154 for storing information, including instructions, that persists even when the computer 150 is turned off or otherwise loses power. Information, including instructions, is provided to the bus 153 for use by the processor 151 from any external input device 156, such as a keyboard containing alphanumeric keys operated by a human user, or a sensor.

A software module refers to a distinct, self-contained segment of code that is designed to perform a specific function within a larger system or application. The software module can be an independently executable component or a library of functions that can be utilized by other software components. For purposes of this application, a software module is defined to include any combination of routines, algorithms, and data structures that interact with other modules within the system to accomplish a defined process or behavior. An algorithm is a defined, systematic sequence of computational steps that transforms input data into output results. The algorithm performs a specific computational task or solves a particular problem, and it is expressed in the form of executable code, mathematical instructions, or other logically structured operations. In this invention, the algorithm is distinguished by its unique approach, steps, or methodologies that improve computational efficiency, scalability, or other technical characteristics in a novel and non-obvious manner. Data processing refers to the manipulation, transformation, or analysis of data using a sequence of operations or algorithms, often in real-time or batch processes. It includes activities such as the extraction, transformation, loading (ETL), aggregation, sorting, and filtering of data. In the context of this invention, data processing refers specifically to a novel technique for managing, optimizing, or interpreting data flows, wherein the claimed invention improves the efficiency or accuracy of data processing by utilizing unique methods or structures that were previously unavailable in prior art.

A user interface (UI) is a collection of elements that allow interaction between a user and a computer system or software application. This includes input mechanisms such as buttons, text fields, and gesture recognition, as well as output displays, such as visual feedback or notifications. In this invention, the user interface is defined by its novel design, layout, or method of interaction that enhances user experience, simplifies task completion, or introduces a new way of presenting information that provides technical advantages over prior user interface designs. A network communication protocol is a set of rules and conventions that govern the exchange of data between devices or systems over a network. These protocols specify the format, timing, sequencing, and error-checking procedures for data transmission. In the context of this invention, the network communication protocol is uniquely designed to address specific challenges in data transfer, such as reducing latency, improving security, or increasing throughput, providing a novel and non-obvious improvement over existing protocols. Cloud computing refers to the delivery of computing services—such as servers, storage, databases, networking, software, and analytics—over the internet (the “cloud”). In this invention, cloud computing is applied in a novel manner that distinguishes it from conventional approaches, whether through unique methods of resource allocation, data redundancy, task execution, or multi-tenant service provision. The invention claims a specific improvement in cloud architecture, resource management, or service delivery that enhances scalability, efficiency, or fault tolerance in ways not previously contemplated. An Application Programming Interface (API) is a set of rules, protocols, and tools that allow different software applications to communicate with one another. It defines the methods and data formats for requesting services or information from a system and for sending responses back. In this invention, the API is distinguished by novel techniques for handling communication between software components, including features such as dynamic endpoint management, automatic version control, or enhanced security mechanisms that improve the interoperability and scalability of the overall system. Artificial Intelligence (AI) refers to the simulation of human intelligence processes by computer systems, particularly the ability to learn, reason, and problem-solve. In this application, AI is employed through a novel method or system for enhancing decision-making, prediction accuracy, or autonomous operation in software applications. The invention claims a unique approach to AI that addresses specific challenges in training models, optimizing decision trees, or managing large datasets in real-time environments, thus providing a technical improvement over existing AI techniques. Machine Learning (ML) is a subset of artificial intelligence that enables systems to automatically improve their performance through experience or exposure to data, without explicit programming for each task. The invention involves a unique method or algorithm for training, validating, or deploying machine learning models that enhances their efficiency, accuracy, or adaptability. The claimed innovation introduces a new technique for processing training data or optimizing model parameters in a way that advances the state of the art in machine learning systems.

Blockchain refers to a distributed ledger technology that allows data to be stored across multiple nodes in a network, providing secure, transparent, and immutable records. The invention uses blockchain in a novel way to address specific technical challenges in areas such as data integrity, transaction validation, or distributed consensus. The innovation may include new consensus algorithms, methods for enhancing scalability, or optimizations for reducing computational overhead in blockchain-based systems, providing an improvement over prior blockchain implementations. A database query is a request for information or manipulation of data from a database, typically written in a query language like SQL. The database query is processed by the database management system to retrieve, insert, update, or delete data according to the request. In this invention, a novel database query optimization technique is disclosed, which improves query execution speed, reduces resource consumption, or enhances data retrieval accuracy in a way that is not found in prior database management systems. A security protocol is a set of standardized procedures and algorithms designed to ensure the confidentiality, integrity, and authenticity of data in a networked environment. In this invention, the security protocol employs a novel technique for encryption, authentication, or authorization that overcomes limitations in existing security methods, offering improved resistance to attacks or unauthorized access, and providing a new technical solution to challenges in secure communications or data protection. Virtualization refers to the creation of virtual (rather than physical) versions of resources, such as servers, storage devices, or network resources, allowing multiple virtual instances to run on a single physical system. This invention uses virtualization in a unique way to improve resource management, enhance fault tolerance, or optimize the performance of virtual environments, addressing specific challenges in managing large-scale, distributed systems that prior art methods could not solve efficiently.

FIG. 1 illustrates a fantasy sports platform 100 for aiding participants in skillfully choosing fantasy athletes with multiple fantasy challenges. The platform 100 advantageously presents participants with an all-in-one experience with multiple customizable platform settings 113. For example, a platform setting 113 controlled by a sporting management module 124, is set where users are engaged in play for an entire sporting season. Another example includes a custom schedule, where participants and a manager pick which games, tournaments, or any other activity that counts for scoring. A further example is a one and done league. Participants choose one player, team, or other appropriate athlete in a one and done league. The participant is blocked from choosing that same athlete at another point during the season. In one and done platform settings 113 a fail-safe is enabled where if a participant fails to select an athlete, the participant still receives an athlete. Any fantasy platform setting 113 can be changed to include a variety of options, including receiving the lowest likelihood athlete to win or a randomly selected athlete for the fail-safe option.

The term fantasy sports or sporting event 101 referenced herein refers to any sports, including but not limited to golf, football, baseball, hockey, soccer, basketball, college sports, NASCAR and other racing, including F1, tennis, MMA, boxing, and any other scoring style sport. Additionally, the term athletes, as used herein, refers to any athlete that a participant in a fantasy sports league chooses. Yet, the athlete does not have to be an individual; it can be a team, a select number of athletes on a team or individual, or any other athletic grouping or selection of athletes. Additionally, the sport is not limited to physical sports. For example, a sporting event 101 is any e-sport, where participants can choose their athletes or e-sport gamers playing in a tournament or competition. Meanwhile athletes and sports are not limited to professional sports and athletes or collegiate athletes, including the NCAA, nor limited to major sports. For example, any Olympic sport such as badminton, judo, table tennis, or any other non-traditional sport is contemplated. The term skill challenges referenced herein means fantasy sports contests that challenge a participant's skill in assembling a team to accumulate the most points based on the athlete's real-world performance. A mini skill challenge is a secondary skill challenge within the main skill challenge, corresponding to fantasy sports' season length and overall winning participant at the season's end.

Advantageously, each participant is presented with numerous skill challenges in an efficient and all-in-one system. Skill challenges include but are not limited to mini skill challenges set at daily, weekly, or monthly periods. Mini skill challenges include but are not limited to randomized daily, weekly, or monthly statistical leaders in select categories. For example, in a fantasy golf 620 setting, the longest drive of the tournament would be a mini skill challenge category. Other mini skill challenges include segments or blocks of games and tournaments or matches within the sports' overall season. Another mini skill challenge includes, in the fantasy golf 620 example, a hole in one. If a participant's chosen athlete achieves a hole in one, the participant wins a predetermined mini skill challenge prize. An additional fantasy golf mini skill challenge includes a missed cut challenge, wherein a one and done platform setting 113, the participant who goes the longest within the league without having an athlete miss a cut in a golf tournament receives a reward. As such, all mini skill challenges are in one efficient platform presented to each participant along with the main skill challenge via a Graphical User Interface (GUI).

Because fantasy sports participants must make an athlete selection using skills and not chance, information about the sport is critical to winning a contest or league. Each participant is presented and prompted with real-time statistics. Other presentations to participants include media content, including articles written by fantasy sports experts, professional analysis, and other similar sports media content. There are numerous plug-ins and add-ons available to participants on the platform 100, including podcasts, news articles, Twitter posts, feeds, and other similar sports news media. Other plug-ins include real-time updated odds and statistics from leading oddsmakers covering a sporting event. Real-time updates regarding statistics and data occur via notifications on a mobile device 605 or other computing devices.

Real-time updates include but are not limited to athlete statistics and data including performance history, career statistics, season statistics, and other relevant data, snap shots where participants receive push or non-push notifications showing which athletes other participants chose. The platform 100 sends recaps that are sent to each participant. The recaps review the past sporting event including show replays of highlights, replays of the entire sporting event that is recorded on the platform 100, animations and emotes of participants scoring based on a sporting event, and statistics and data of athletes and participants based on a sporting event. Additionally, the platform 100 sends email notifications and creates mobile device 605 badges, messages, and alerts. Of which include a pick reminder if the participant did not choose an athlete when the participant's lineups are locked and the results of the set time period, season, tournament, or sporting event. In an embodiment of the present invention, participants are presented with a GUI that displays real-time statistics as referenced herein, selected media content as plug ins, and a selection module to select an athlete.

The platform 100 features a computing device 170 with a memory 105, a data processor 104, and a local program product 102 installed. The local program product 102, referred to herein, is software and can be embodied as an application installed on a computing device 170 featuring a plurality of modules and also as programs stored in memory and/or cached on a device via an internet browser and website functionalities. The local program product 102 is preferably embodied as a downloadable application with its corresponding computer code. The memory 105 referenced can be any form of storage medium including, but not limited to random access memory (RAM), read-only memory (ROM), erasable programmable read only memory (EPROM), a cache, a hard drive, a flash drive, a removable disk, a Secure Digital card (SD card), cloud computing 133, registers, and/or memory buffer, or any combination thereof. The memory 105 can be in communication with a data processor 104 such that the data processor 104 can read information from and write information to the memory 105. Further, the data processor 104 can utilize any suitable processing device configured to run or execute a set of instructions or code, e.g., stored in the memory 105, such as a central processing unit (CPU), general purpose processor (GPP), a graphics processor unit (GPU), a digital signal processor (DSP), an application specific integrates circuit (ASIC), a field programmable gate array (FPGA), local program product, or any other programmable logic device, discrete gate or transistor logic, discrete hardware components, controller, microcontroller, or any combination thereof, designed to perform the functions described herein. For example, the data processor 104 and memory 105 integrate with and run with an installed local program product 170 on a mobile device.

The platform 100 utilizes a computing device 170 and provides AR and VR components. For example, AR is integrated with participants' athlete selections via a GUI. AR and VR implementations include group watch room where each participant can watch a sporting event with other participants in their league and on the platform 100. In an embodiment of the present invention, a participant's mobile device and through its connection on a network and/or WIFI will send a notification that another participant is nearby and to join a watch party, which is preferably in AR or VR format, but not required. The local program product 102 accesses a computing device's GPS data to determine a participants location. A watch party can be implemented without AR and VR using traditional videoconferencing means via a GUI on the local program product 102, the implementation of which would be apparent to one of ordinary skill in the art. During a group watch room, participants are presented with a video stream of a sporting event, or multiple streams of multiple sporting events in a multi-window format, real-time statistics, and other media content referred to herein, while watching, discussing, and commenting on the sporting event. In an embodiment of the present invention, the group watch room features a group view module 109, where each participant is grouped together and can watch the sporting event that their league pertains to. Each participant can create an avatar or use a picture, so their identities are known. After creating an avatar, each participant is presented with security questions to verify their identification and account. Participants also have the option to be virtually transported via VR to appear at the exact sporting event they are watching. For example, participants will be virtually transported via VR to view the scene from a specific hole on a golf course, following specific players, sitting in a virtual seat, or virtually walking with a grouping of golfers at an event, the implementation of which would be apparent to one of ordinary skill in the art.

Furthermore, in the context of AR and VR, wearable AR and VR technologies are expected to be readily adopted through the processing power and memory 105 of a participant's mobile device. For example, a mobile device, via a local program product 102 for fantasy sports, links participants into viewing streams of their selected sporting event so each participant can virtually be at the event. The local program product 102 of the computing device has a plurality of modules. The modules are any assembly and/or set of operatively-coupled electrical components that can include, but is not limited to, a memory 105, a data processor 104, software (executing in hardware) 102, or the like. In some embodiments, the plurality of modules can be software modules or hardware modules stored in the memory 105 and/or executed in the data processor 104. In other embodiments, the plurality of modules can be any combination of a hardware-based module, e.g., a FPGA, an ASIC, a DSP, and/or software-based module, e.g., a module of computer code stored in memory 105 and/or executed at the data processor 104, capable of performing one or more specific functions associated with that module.

In an embodiment of the present invention, an AR enabled platform 100 for fantasy golf is presented. A computing device's 170 camera and sensors capture a participant's surroundings via an installed local program product 102. The local program product 102 collects and processes data corresponding to the camera's input and determines the location of an AR object. For example, a golf related object. The AR golf object is displayed in real time on a participant's computing device's screen. An AR module 175 uses depth sensors, accelerometers, cameras, gyroscopes, and light sensors to collect data on a participant's surroundings to measure the distance to the objects, speed of the motion, direction and angle, and overall orientation in space. The data is then processed via the local program product 102 to show animation in real-time and relevant location.

In another embodiment of the present invention, the local program product 102 activates and accesses a computing device's 170, and specifically, a mobile device's microphone, to use its voice-searching features. For example, a participant using the local program product 102 on their mobile device accesses the phone's voice searching either while in a watch party or being presented with AR and VR viewing to search for relevant fantasy sports statistics. A participant watches the sporting event while asking the local program product 102 to do research that helps the participant in deciding which athlete to choose. The participant's voice is registered and saved to a voice profile that is assigned to a specific user that can also correspond to its customized avatar. Other voice activities include but are not limited to searching the internet, playing music, or recording a voice to attach to a custom NFT. In addition, since a participant's voice commands are saved, the platform utilizes machine learning to automate settings that are frequently used, the implementation of which would be apparent to one of ordinary skill in the art. For example, if a participant searches for the score of one team or athlete every morning, it will be already presented on a computing device 170 to that participant either on a GUI, a notification, via AR and/or VR, announced aloud, or any other notification or badge, that is desirable to a participant, the implementation of which would be apparent to one of ordinary skill in the art.

In another embodiment of the present invention, the platform 100 provides participants with an online marketplace 180. At this marketplace 180, participants can create NFTs, sell them, and perform trades. A valuation module 112 of the local program product 102 creates a value for each NFT based on the scarcity, the author, the time to create, the number of likes, and other relevant valuation data. The NFTs can correspond to specific sporting events. For example, a Masters NFT would be awarded to the participant who scores the most points via their athlete at the Masters on the PGA tour. That NFT, with its value, can be awarded as payment and transferred to a participant's account. Alternatively, or in addition, the NFT can be transferred to each participant that wins a sporting event 101 each year, or new NFTs are created routinely. Because of the AR and VR features, the NFTs can be 3D and include AR/VR implementations.

Additionally, the platform 100 has a payment management module 120 that creates a secure payment transfer system that utilizes virtual currency, traditional forms, and NFTs. The payment management module 120 transfers the reward to the winning participant, whether the participant wins a main skill challenge or a mini skill challenge. In connection with the payment management module 120, the network communication protocol 108 controls the network connection 129, allowing participants to receive and transfer funds and rewards. In addition, the communication protocol 108 enables the network connection 129 for the platform's scoring module 107, which has scoring settings 128 that are customizable. A security protocol 193 is a set of standardized procedures and algorithms 103 designed to ensure the confidentiality, integrity, and authenticity of data in a networked environment. In this invention, the security protocol 193 employs a novel technique for encryption, authentication, or authorization that overcomes limitations in existing security methods, offering improved resistance to attacks or unauthorized access, and providing a new technical solution to challenges in secure communications or data protection.

The scoring module 107 creates a plurality of scoring categories 810 includes creating the categories selected from a group consisting of: strokes over/under par, scoring average, birdie average, strokes gained, driving distance, and greens in regulation.

The platform 100 also features a management module 106 with a platform management module 115, which controls all participant's activities. For example, the platform management module 115 presents participants with the instructions and rules of the skill challenges. Additionally, it manages and saves each participant's initial investment and membership plan. Under the management module 106, a participant interacts 144, creating user input and user output 144 through a GUI 134 that is implemented via the network connection 129. The GUI 134 features a non-limiting list of VR and AR components, keyboard and mouse, speakers, a microphone, a touch screen implementation, video display, haptic feedback, and other media content, including podcasts, articles, and expert fantasy sports analysis. On the GUI 134, a participant selects their athletes via a selection module 110. Meanwhile, the participant interacts 144 with multi-user VR and AR watch parties and mobile devices. The VR and AR also utilizes the selection module 110 to aid a participant in choosing an athlete by displaying athlete statistics and data from a database processed from the database query 111. The database processed in the database query 111 includes odds for an athlete winning, expert analysis rankings, and other relevant data.

The local program product stores in its database 111 highlights of a sporting event 101, stored video streams of the entirety of a sporting event, data of athlete's fantasy scoring and season scoring, and other media. In an embodiment, the local program product 102 only selects the participant chosen athletes to record and track data for. Thus, becoming faster tracking in real-time, being more efficient, and causing less storage.

In an embodiment of the present invention, the platform 100 presents a fantasy golf sporting event that creates a plurality scoring categories 810 associated with a golf sporting event via the scoring module 107. The plurality of scoring categories 810 include strokes over/under par, scoring average, birdie average, strokes gained, driving distance, and greens in regulation. The term strokes refers to a golfer's strokes in accordance with it being over or under that particular course's set par. The scoring module 107 assigns a percentage of points to each scoring category 810. This percentage is assigned by a league manager, authorized participant, voting by participants, or another setting that is predetermined. The scoring module 107 then collects, in real-time athlete statistical data that corresponds to a sporting event from a database 111. The platform 100 then presents a participant with a GUI 815 to select an athlete participating in the sporting event 101. At the GUI 815 athlete statistics and data are shown to participants. The statistics, data, and GUI overlay can be in AR and/or VR format. Additionally, the GUI 815 displays all available skill challenges, including mini skill challenges for participants to choose from. The platform 100 records, in real time all athlete's statistics performing in the sporting event 101 and also records an entire video stream of the sporting event 101, including top highlights played on sport TV channels, including but not limited to Barstool Sports, ESPN, and other sports news outlets. The platform 100 displays in real-time athlete's performances in the sporting event 101 and can send a notification to a participant informing the participant of their chosen athlete's performance. The scoring module 107 translates an athlete's performance according to the scoring categories from the sporting event 101 into points associated with the percentages of points associated with each scoring category. The scoring module 107 calculates the total amount of points for an athlete and transforms the total amount of points into rewards. The rewards are then distributed via the payment management module 120 and distributed via a secure transfer. The secure reward transfer via the payment module 120 features traditional forms of banking but also transfers NFTs and cryptocurrencies at set-intervals or automatically.

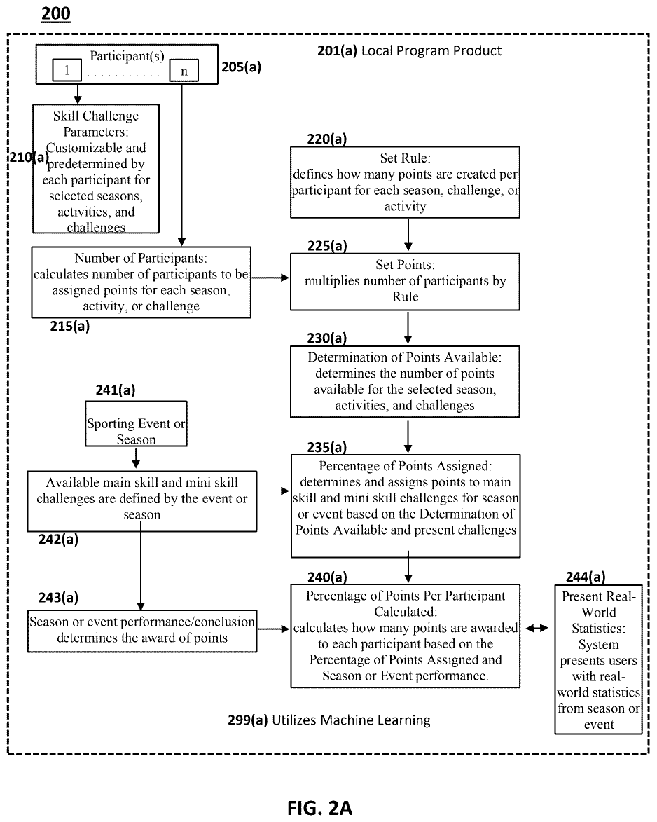

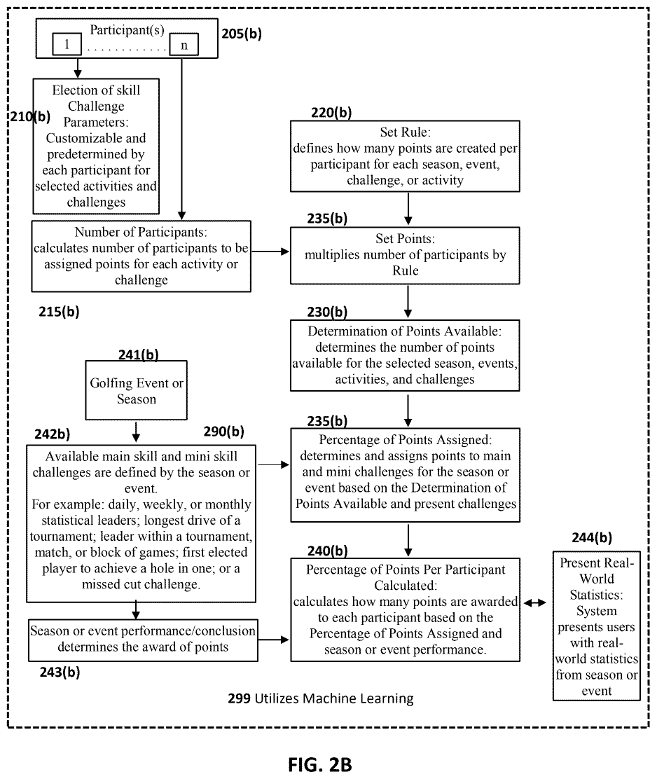

FIG. 2A illustrates a scoring system 200 relating to fantasy sports skill challenges. All skill challenge parameters 210 are customizable and pre-determined by a participant, participant votes, or a league manager. Additionally, it is noted that the term point can also be referred to as a dollar for scoring and payment/transaction purposes. The steps are embodied as and implemented through a local program product 201 software. At step 220, the local program product 201 creates a set rule for defined points per participant 205. At step 215, the number of participants is calculated. At step 225, the number of participants is multiplied by the number of defined points per participant. Step 230 provides the result of the multiplication to create the total available points. Step 235 defines the percentage of a main skill challenge with the other mini skill challenges included. For example, in fantasy golf, the tournament, any Major (tournaments), segments (blocks of time), skins, and mini skill challenges including a missed cut, hole in one, and weekly statistical event are all given differing percentages of points if won by a participant. The percentages are factored (multiplied) into the total available points to determine each participant's total points at step 240.

In an embodiment of the present invention, a fantasy golf scoring system is shown in FIG. 2B. Depending on how many participants, first place will receive 30%, second 15%, and third 5%. Meanwhile, after a participant has chosen an athlete, all Majors receive a payout. For example, the Masters, US Open, Players Championship, British Open, and the PGA Championship all are worth 5%. The participant who uses their skill and chooses the lowest score via the participant's chosen athlete wins or receives the first place reward or payout percentage. The golf season is broken into six segments, where the participant's chosen athletes who have accumulated the most earnings during that segment receives the specified percentage. For ease, each segment is 3%. A skin is rewarded when the participant's chosen athlete wins a tournament. Additionally, if the reward for a carry over is less than $10, a carry-over occurs. The term carry over as used herein means that if no user wins a mini skill challenge or a certain amount of users choose the same athlete, and the users' winnings result in less than a predetermined amount, the reward is cancelled for that week, and carried over to the next week. Thereby, resulting in a larger reward, prize, or amount. Weekly mini skill challenges 290 occur where participants receive predetermined rewards each week. Whomever is the last participant to not have chosen an athlete that has missed a cut, the participant is rewarded. If a participant's athlete achieves a hole in one for that week, the participant wins the reward. Finally, for the Fed Ex Cup, there are mini skill challenges, where the combined winnings of each participant's chosen athletes, that is the highest, wins for the four weeks.

The scoring system also uses adaptive, machine learning 299 scoring techniques to continuously add more points, change points, or any other change that is desired. By being adaptive, participants do not have to manually enter data or configure data because the local program product 201 determines the ratio automatically through machine learning 299.

In an embodiment of the present invention, the scoring system 200 provides a method for scoring fantasy golf events 645. The scoring system 200 utilizes a computer, its memory, and data processor 104 via an installed local program product 201 with corresponding computer program code to create a point value that corresponds to a scoring category associated with a sporting event. The point value is then set according to a predetermined input value as desired by a participant. Predetermined input value as used herein refers to any participant setting, which can be a point value for a scoring category. The local program product 201 calculates an athlete's point values according to the set point value. More specifically, the local program product 201 calculates a main skill challenge point total, determines the number of participants, determines the number of points and divides the total points by the number of participants. This step creates a point per participant based on the number of participants. The local program product 201 then multiplies the number of points per participant with the number of participants to achieve a total available amount of points for a sporting event. The total amount of points is then divided by a predetermined percentage of winnings which is then divided by the total available points associated with each scoring category. This step creates a points per scoring category percentage. The scoring system 200 occurs in real-time during a sporting event so participant's points are calculated while watching an event. Meanwhile, the scoring system 200 utilizes machine learning and AI learning to automate the scoring to achieve more efficient and faster results. The scoring system 200 determines a winning participant based off of calculated points and sends a reward. Such reward may be an NFT. Additionally, the scoring system 200 shares sporting event data and statistics with other viewer devices on a network. Viewer devices herein refers to computing devices connected via a network that have the local program product installed and thus are participating in the fantasy sports event.

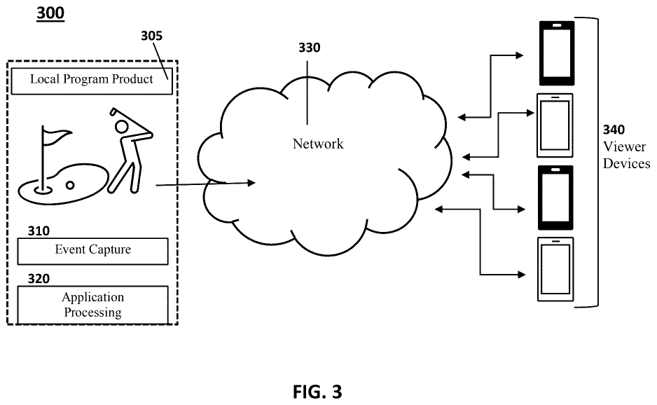

As illustrated in FIG. 3, a sharing system 300 for fantasy sports allows participants to interact with one another while watching the corresponding sporting event 310. Multimedia information is recorded from the sporting event's stream and then processed 320. After the multimedia information is processed 320, it is outputted to various devices. For example, the processed multimedia information can be sent to viewing devices 340 via a network 330. Such viewing devices 340 may include phones, televisions, monitors, computers, desktop computers 605, laptop computers, kiosks, smartphones, portable electronic devices, tablets, or any other device comprising a screen. One or more of the viewing devices 340 may communicate with other viewing devices through the communication network 330 or directly, for example, via Bluetooth. In an embodiment utilizing watch parties, for example, the viewing devices 340 may be associated with different participants in the watch party. A communication network 330 may be the internet or any wired or wireless communication network, the identification and implementation of which are apparent to one of ordinary skill in the art.

In another embodiment of the present invention, and as referenced herein regarding AR and VR applications, a participant is notified about other nearby participants. The process uses spatial computing. For example, while on a network 330, a participant's mobile device 340 via its GPS and accelerometer, determines that participant's location compared to other participants. Their locations are then mapped out so other participants can view if that security preference is enabled. The system uses spatial computing to enable each participant to interact with each other in an AR and VR context. For example, a virtual overlay on a mobile device is presented to a participant that streams a sporting event with real-time data and statistics. The system works by using a computing device's photogrammetry, lidar, and radar to capture a 3D model of the event and its corresponding video stream. Lidar and radar capture a 3D model by measuring the reflection of a laser or radio signal off objects around to automatically capture a point cloud representing the distance to each point. Whereas photogrammetry is creating 3D models from photographs, combining imagery from multiple images or cameras. Additionally, other techniques like neural radiance fields (NeRF) can capture a richer representation using a minimal number of images for the system 300. In addition, the system uses machine vision to analyze the collected image data, detect a scene, look for defects, understand gait patterns, and analyze how different workers perform a process. The spatial computing technique will then perform a desired action, preferably automatically, if desired by a participant. For example, the local program product 305 will decide to automatically notify a participant if there is a nearby participant when a sporting event has started, presenting a participant with secure payment options and other advantages to automating fantasy sports activities.

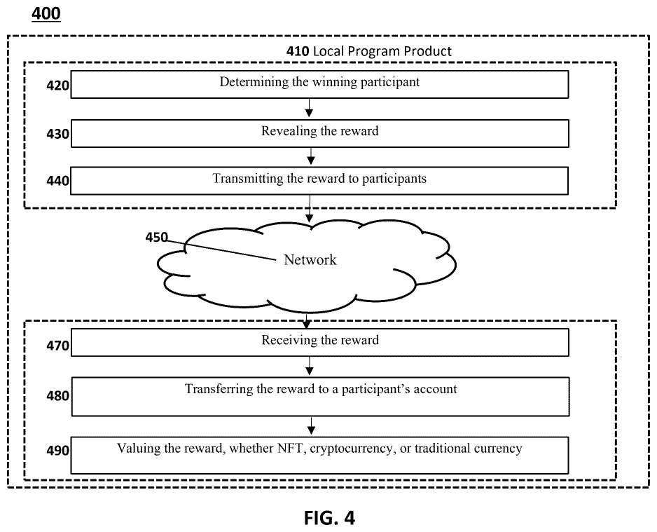

As illustrated in FIG. 4, secure reward transfer system 400 utilizes a virtual currency for transactions involving fantasy sports. Transactions are user-specific, automated, and accept all possible forms of currency, including cryptocurrency, PayPal, Venmo, and any other similar online payment platforms. Transactions are recorded on a blockchain 191 to ensure the security and integrity of payment. Any cryptocurrency allows users to transact quickly without requiring verification from an external source. Cryptocurrency and blockchain 191 technology allow participants to securely exchange funds in real-time without requiring verification from an outside source, preventing waiting for payment verification. Blockchain 191 refers to a distributed ledger technology that allows data to be stored across multiple nodes in a network, providing secure, transparent, and immutable records. The invention uses blockchain 191 in a novel way to address specific technical challenges in areas such as data integrity, transaction validation, or distributed consensus. The innovation may include new consensus algorithms 103, methods for enhancing scalability, or optimizations for reducing computational overhead in blockchain-based systems, providing an improvement over prior blockchain 191 implementations. In addition, reward transfer system 400 automates payment. The participant can pre-configure settings in the system. For example, if a participant's account reaches a certain threshold value, then it is deposited into their bank account or other desired account automatically. It is noted that the secure money transfer system transfers cryptocurrency and any other currency, including Venmo, Zelle, bank transfers, check deposits, NFTs, or any other currency, whether virtual or not.

While the use of AR and VR is referenced herein, and spatial computing is used to achieve the integration, the use of spatial computing means that certain 3D points are detected, including a participant's facial structure. Accordingly, facial recognition can be used by participants to receive winnings, store the winnings, and then transfer their winnings to their appropriate bank or account. The local program product 410 can access a participant's mobile device and access its facial recognition feature.

In another embodiment of the present invention, the local program product 410 determines the winning participant 420. After determining the winning participant, whether a main or mini skill challenge, the reward is revealed 430 to the winning participant. Revealing the reward informs participants of their NFT and its value and/or dollar amount earned. The reveal can be performed via AR/VR technology to create a more engaging experience for the participant. After revealing 430, the system 400 transmits the reward 440 to the participants in a secure fashion via a network 450. After receiving the reward 470, the reward is then transferred to the participant's account 480. This transferring step 480 is adaptive in that, if a participant is rewarded an NFT, it is transferred to the participant's NFT account. Where a cryptocurrency such as Bitcoin is rewarded, the reward is transferred to the participant's Bitcoin account, such as Binance. After the transfer 480, the local program product 410 values the reward 490.

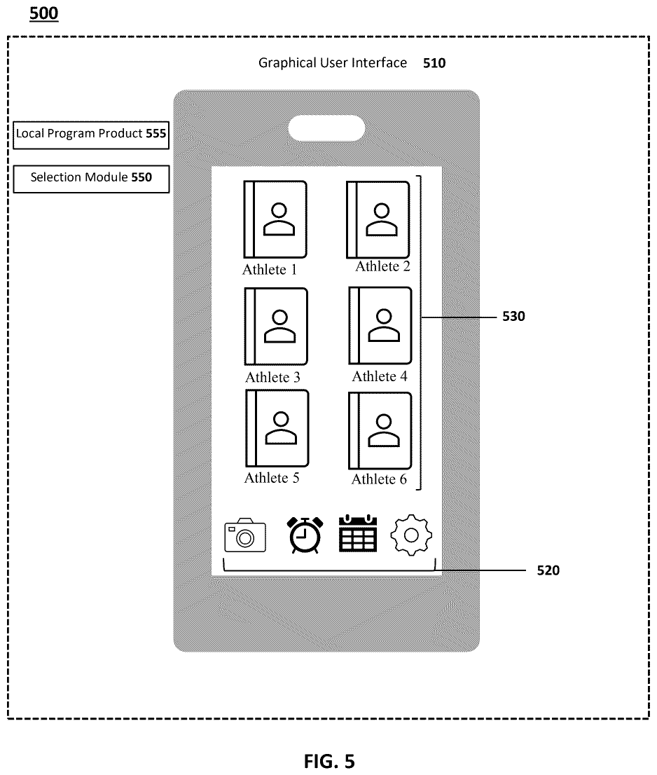

FIG. 5 illustrates a method and system of selecting athletes 530 in a fantasy sports setting via a selection module 550 of a GUI 510. In an embodiment of the present invention, participants are presented with a GUI 510 that displays all current athletes 530 to choose from, depending on the league's setting. For example, if it is a one and done league or another style format. All athletes 530 available are presented to the participant in an efficient format, i.e., GUI 510, where each participant also is presented with real-world statistics, expert analysis, and other relevant fantasy sports data that help to inform a participant with their athlete decision. In another embodiment of the present invention, the GUI 510 is presented in an AR/VR format where each participant views a 3D and interactive presentation of available athletes 530 to choose from. While viewing in AR and VR, a participant can read information and receive detailed analysis before they choose an athlete, all while in the local program product 555. In addition, the GUI 510 and through its installed local program product 555 displays numerous plug-ins 520 for participants to utilize. A non-limiting list of plug ins include Twitter feeds, weather, ESPN, Google, platform settings, a timer, camera, video camera, calendar, and any other plug in relative to providing fantasy sports expertise, analysis, and advice.

In an embodiment of the present invention, a GUI 510 and a local program product 555 presents a main skill challenge and a mini skill challenge to participants with corresponding decisions for participants to make. For example, a participant will choose an athlete that corresponds to a main and/or mini skill challenge. The GUI presents the athlete with statistics in VR and AR format. The statistics include relevant athlete data 850 as referenced herein. While displaying statistics, a video stream of the sporting event corresponding to the challenge can be played. Because the video stream can be played, it allows for a group watch room where other participants can all watch the sporting event together via the local program product 555 via the GUI 510.

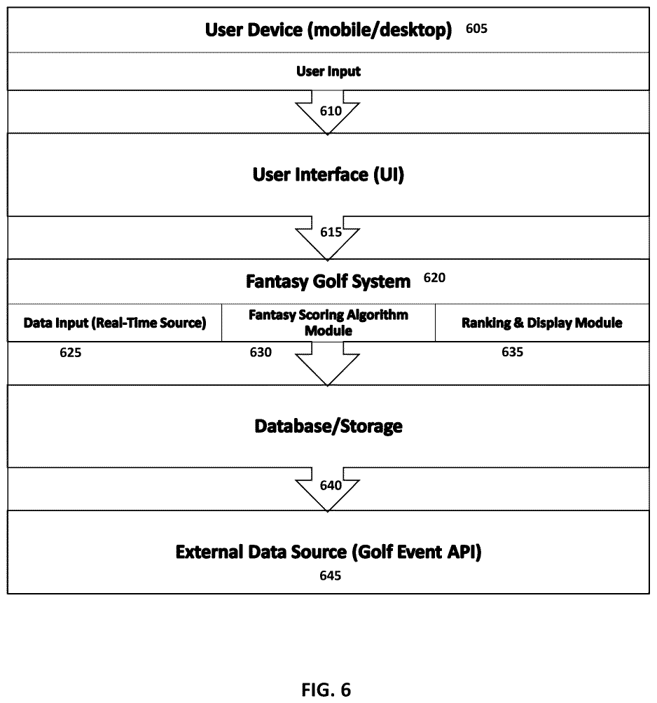

FIG. 6 provides a computer-implemented method and system for virtualizing a fantasy sports experience. The method includes defining a plurality of scoring categories for a sporting event, dynamically calculating scores based on real-time athlete performance, and distributing digital rewards to users. The system integrates real-time data collection, processing, and communication technologies to deliver a seamless user experience.

The invention further supports features such as blockchain-enabled reward distribution, the use of machine learning for athlete recommendations, and interactive graphical user interfaces (GUIs) for user engagement. The platform facilitates real-time scoring, ranking adjustments, and notifications to keep users informed about their team's performance during live events.

For a Method for Virtualizing a Fantasy Sports System, including Scoring Categories and Data Collection, the present invention involves creating a plurality of scoring categories associated with a sporting event. Examples of scoring categories include touchdowns, yards gained, or defensive stops. A graphical user interface (GUI) displays these categories alongside a list of participating athletes and their real-time statistical data. The system collects this data by querying a database over a network 805.

In an embodiment, an algorithm outlines the steps of virtualizing a fantasy sports system. Step 1: Initialize Fantasy Sports System 1. Define a list of scoring categories associated with a sporting event. 2. Assign a percentage weight to each scoring category. 3. Establish a database for tracking real-time athlete statistics. 4. Create a pool of athletes participating in the sporting event. Step 2: User Interaction & Athlete Selection 5. Display a Graphical User Interface (GUI) for users to select athletes. 6. Retrieve and present real-time statistical data of available athletes. 7. Allow the user to select an individual athlete for their fantasy team. 8. Store the user's selected athlete data in memory. Step 3: Real-Time Performance Tracking 9. Continuously collect real-time athlete performance data from a live database query. 10. Store and update athlete performance data in real-time. Step 4: Fantasy Points Calculation 11. Retrieve the selected athlete's real-time performance data. 12. Process the data according to the pre-defined scoring categories. 13. Multiply each scoring category's value by its assigned percentage. 14. Calculate the total fantasy points for each athlete. 15. Sum up the total fantasy points for the user's selected team. Step 5: Reward System & Notifications 16. Convert the total fantasy points into a digital reward (e.g., cryptocurrency, NFT, or token). 17. Securely transfer the digital reward to the user's mobile device via a security protocol. 18. If applicable, execute the reward transfer using blockchain technology. 19. Send a push notification to the user with athlete performance updates. Step 6: Additional Features & Real-Time Adjustments 20. Display a leaderboard showing real-time rankings of all participants. 21. Allow users to view skill challenges and additional point-based achievements. 22. Adjust fantasy scores dynamically throughout the event. 23. Provide AI-based recommendations for athlete selection using machine learning. Step 7: Tournament Management & Ranking 24. Compare all users' total fantasy scores. 25. Determine the highest-scoring user as the winner. 26. Adjust rankings dynamically based on event-specific conditions (e.g., venue difficulty). 27. Share real-time fantasy game statistics with all users over the network. Step 8: System Storage & Data Processing 28. Store all event, player, and scoring data on a non-transitory computer-readable medium for future reference. 29. Continuously analyze player historical data for predictive insights. 30. Update the system with post-event results for future AI-based recommendations.

In an embodiment, this implementation is written in Python using Flask (for the backend), SQLite (for the database), and WebSockets (for real-time updates). It includes real-time data collection, athlete selection, fantasy score calculation, digital rewards (NFT/crypto), push notifications, and AI-based recommendations.

### Fantasy Sports System Implementation

from flask import Flask, request, jsonify
import sqlite3
import json
import random
import time
import threading
import requests
app=Flask(_name_)
#Database Initialization
def init_db( ):
   conn=sqlite3.connect(‘fantasy_sports.db’)
   cursor=conn.cursor( )
   cursor.execute(“‘CREATE TABLE IF NOT EXISTS athletes (id INTEGER PRIMARY KEY, name TEXT, team TEXT, position TEXT, stats TEXT)’”) cursor.execute(“‘CREATE TABLE IF NOT EXISTS users (id INTEGER PRIMARY KEY, name TEXT, team TEXT, points INTEGER)’”)
   conn.commit( )
   conn.close( )
init_db( )
#Scoring System
SCORING_CATEGORIES={
   “points”: 0.4,
   “rebounds”: 0.3,
   “assists”: 0.2,
   “steals”: 0.1
}
#Real-time athlete statistics simulation def update_athlete_stats( ):
   while True:
      conn=sqlite3.connect(‘fantasy_sports.db’)
      cursor=conncursor( )
      cursor.execute(“SELECT id FROM athletes”)
      athletes=cursor.fetchall( )
      for athlete in athletes:
         stats=json.dumps({
         “points”: random.randint(5, 30),
         “rebounds”: random.randint(1, 15),
         “assists”: random.randint(1, 10),
         “steals”: random.randint(0, 5)
         })
         cursor.execute(“UPDATE athletes SET stats=? WHERE id=?”, (stats, athlete[0]))
      conn.commit( )
      conn.close( )
      Time.sleep(10) #Update every 10 seconds
#Start real-time athlete updates in a separate thread
threading. Thread(target=update_athlete_stats, daemon=True).start( )
#Athlete selection
@app.route(‘/select_athlete’, methods=[‘POST’])
def select_athlete( ):
   data=request.json
   user_id=data[‘user_id’]
   athlete_id=data[‘athlete_id’]
   conn=sqlite3.connect(‘fantasy_sports.db’)
   cursor=conn.cursor( )
   cursor.execute(“UPDATE users SET team=? WHERE id=?”, (athlete_id, user_id))
   conn.commit( )
   conn.close( )
   return jsonify({“message”: “Athlete selected successfully”}), 200
#Fantasy Score Calculation
@app.route(‘/calculate_score’, methods=[‘GET’]) def calculate_score( ):
   conn=sqlite3.connect(‘fantasy_sports.db’)
   cursor=conn.cursor( )
   cursor.execute(“SELECT id, team FROM users”)
   users=cursor.fetchall( )
   results=[ ]
   for user in users:
      user_id, athlete_id=user
      cursor.execute(“SELECT stats FROM athletes WHERE id=?”, (athlete_id,))
      stats=cursor.fetchone( )
      if stats:
         stats=json.loads(stats[0])
         score=sum(stats[category]*SCORING_CATEGORIES[category] for category in SCORING_CATEGORIES)
         cursor.execute(“UPDATE users SET points=? WHERE id=?”, (score, user_id))
         results.append({“user_id”: user_id, “score”: score})
   conn.commit( )
   conn.close( )
   return jsonify(results), 200
#Generate NFT as a reward (Simulated)
@app.route(‘/generate_nft’, methods=[‘POST’])
def generate_nft( ):
   data=request.json
   user_id=data[‘user_id’]
   points=data[‘points’]
   nft_data={
      “user_id”: user_id,
      “points”: points,
      “nft_id”: random.randint(1000, 9999)
   }
   #Simulating blockchain transfer
   return jsonify({“message”: “NFT transferred successfully”, “nft_data”: nft_data}), 200
#Push Notifications (Simulated)
@app.route(‘/send_notification’, methods=[‘POST’])
def send_notification( ):
   data=request.json
   user_id=data[‘user_id’]
   message=data[‘message’]
   #Simulating push notification
   return jsonify({“message”: f“Notification sent to User {user_id}”, “content”: message}), 200
#AI-Based Athlete Recommendations
@app.route(‘/recommend_athletes’, methods=[‘GET’])
def recommend_athletes( ):
   conn=sqlite3.connect(‘fantasy_sports.db’)
   cursor=conn.cursor( )
   cursor.execute(“SELECT id, name, stats FROM athletes”)
   athletes=cursor.fetchall( )
   recommendations=[ ]
   for athlete in athletes:
      athlete_id, name, stats=athlete
      stats=json.loads(stats)
      performance_score=sum(stats[category]*SCORING_CATEGORIES[category] for category in SCORING_CATEGORIES)
      recommendations.append({“athlete_id”: athlete_id, “name”: name, “score”: performance_score})
   #Sort recommendations by performance
   recommendations=sorted(recommendations, key=lambda x: x[“score”], reverse=True)
   conn.close( )
   return jsonify(recommendations[:5]), 200 #Return top 5 recommendations
#Run Server
if _name_==‘_main_’:
   App.run(debug=true)

Features Implemented: Real-time athlete stats updates (Simulated with random values); User selection of athletes; Fantasy score calculation based on pre-defined categories; NFT-based digital rewards (Simulated); Push notifications for performance updates; AI-powered athlete recommendations based on historical stats. How it Works 1. Initialize Database—Stores athletes and users. 2. Real-time Stat Updates—Background thread updates stats every 10 seconds. 3. User Selects Athlete—API call assigns an athlete to a user's fantasy team. 4. Score Calculation API calculates user fantasy scores based on real-time stats. 5. NFT Rewards—Top players receive an NFT (simulated as JSON). 6. Push Notifications-Sends alerts about player performance. 7. AI Athlete Recommendations—Uses scoring rules to suggest the best athletes. Extending the code with blockchain integration, leaderboards, or dynamic ranking algorithms is implemented for a fantasy sports system using Python and Flask for backend API services, React for the frontend, and a PostgreSQL database. This code covers real-time data collection, scoring, leaderboard management, and blockchain-based reward distribution.

### Backend (Flask-Python)

### Setting up the API:

from flask import Flask, request, jsonify
from flask_sqlalchemy import SQLAlchemy
import requests
import random
import json
import blockchain_utils #Custom module for blockchain transactions
app=Flask(_name_)
app.config[‘SQLALCHEMY_DATABASE_URI’]=
‘postgresql://user:password@localhost/fantasy_sports’
db=SQLAlchemy(app)
#Models
class Athlete(db. Model):
   id=db.Column(db.Integer, primary_key=True)
   name=db.Column(db.String(80))
   team=db.Column(db.String(80))
   position=db.Column(db.String(20))
   statistics=db.Column(db.JSON)
class User(db.Model):
   id=db.Column(db.Integer, primary_key=True)
   username=db.Column(db.String(80), unique=True)
   team=db.Column(db.JSON)
class Leaderboard(db.Model):
   id=db.Column(db.Integer, primary_key=True)
   user_id=db.Column(db.Integer, db.ForeignKey(‘user.id’))
   score=db.Column(db.Integer)
#Function to fetch real-time data
   def fetch_real_time_data(athlete_id):
   api_url=f“https://sportsdataapi.com/player/{athlete_id}”
   response=requests.get(api_url)
   return response.json( )
#Assigning scores based on performance
def calculate_score(statistics, scoring_rules):
   score=0
   for category, percentage in scoring_rules.items( ):
      score+=statistics. get(category, 0)*(percentage/100)
   return score
#API to select players
@app. route(‘/select_athlete’, methods=[‘POST’])
def select_athlete( ):
   data=request.json
   user=User.query.get(data[‘user_id’])
   if not user:
      return jsonify({“error”: “User not found”}), 404
   user.team=data[‘selected_athletes’]
   db.session.commit( )
   return jsonify({“message”: “Team selected successfully”})
#API to update leaderboard
@app.route(‘/update_leaderboard’, methods=[‘POST’])
def update_leaderboard( ):
   users=User.query.all( )
   for user in users:
      score=sum(calculate_score(fetch_real_time_data(a_id), {“goals”: 40, “assists”: 20, “saves”: 10}) for a_id in user.team)
      leaderboard_entry=Leaderboard.query.filter_by(user_id=user.id).first( )
      if leaderboard_entry:
         leaderboard_entry.score=score
      else:
         new_entry=Leaderboard(user_id=user.id, score=score)
         db.session.add(new_entry)
   db.session.commit( )
   return jsonify({“message”: “Leaderboard updated”})
#API to transfer rewards using blockchain
@app.route(‘/transfer_rewards’, methods=[‘POST’])
def transfer_rewards( ):
   data=request.json
   user_id=data[‘user_id’]
   score=Leaderboard.query.filter_by(user_id=user_id).first( ).score
   reward=blockchain_utils.create_nft(user_id, score)
   return jsonify({“message”: “Reward transferred”, “reward”: reward})
if _name_==‘_main_’:
   db.create_all( )
   app.run(debug=True)

### Frontend (React.js)

### Main Components:

1. User Dashboard (Displays player selection and leaderboard updates)
2. Player Selection (Allows users to draft players)
3. Live Scoreboard (Updates fantasy points dynamically)

### React Code (Dashboard Component)

import React, {useEffect, useState} from ‘react’;
const Dashboard=( )=>{
   const [leaderboard, setLeaderboard]=useState([ ]);
   const [players, setPlayers]=useState([ ]);
   useEffect(( )=>{
      fetch(‘/update_leaderboard’)
         .then(response=>response.json( ))
         .then(data=>setLeaderboard(data));
   }, [ ]);
   useEffect(( )=>{
      fetch(‘/get_athletes’)
         then(response=>response.json( ))
         .then(data=>setPlayers(data));
   }, []);
   const handlePlayerSelection=(selectedPlayers)=>{
      fetch(‘/select_athlete’, {
         method: ‘POST’,
         headers: {‘Content-Type’: ‘application/json’},
         body: JSON.stringify({user_id: 1, selected_athletes: selectedPlayers})
      }).then(response=>response.json( ));
   };
   return (
      <div>
         <h1>Fantasy Sports Dashboard</h1>
         <h2>Live Leaderboard</h2>
         <ul>
         {leaderboard. map((entry, index)=>(
         <li key={index}>{entry. username}-{entry.score} points</li>
         ))}
         </ul>
         <h2>Select Players</h2>
         <ul>
         {players.map(player=>(
         <li key={player.id}>
         p{player.name}-{player.team}
         <button onClick={( )=>handlePlayerSelection([player.id])}>Select</button>
         </li>
         ))}
         </ul>
      </div>
   );
};
export default Dashboard;

### Blockchain & NFT Rewards

Blockchain Utility Module (blockchain_utils.py)
from web3 import Web3
#Connect to Ethereum Blockchain (Replace with actual provider)
w3=Web3(Web3.HTTPProvider(“https://eth-mainnet.alchemyapi.io/v2/YOUR_API_KEY”))
contract_address=“0xYourNFTContractAddress”
contract_abi=json.load(open(‘nft_abi.json’))
contract=w3.eth.contract(address=contract_address, abi=contract_abi)
def create_nft(user_id, score):
   user_wallet=“0xUserWalletAddress” #Fetch from DB
   txn=contract.functions.mint(user_wallet, score).buildTransaction({
      ‘from’: “0xYourWalletAddress”,
      ‘gas’: 500000
   })
   signed_txn=w3.eth.account.signTransaction(txn, private_key=“YOUR_PRIVATE_KEY”)
   txn_hash=w3.eth.sendRawTransaction(signed_txn.rawTransaction)
   return txn_hash.hex( )
Database Schema (PostgreSQL)
CREATE TABLE athletes (
   id SERIAL PRIMARY KEY,
   name VARCHAR(100),
   team VARCHAR(100),
   position VARCHAR(50),
   statistics JSONB
);
CREATE TABLE users (
   id SERIAL PRIMARY KEY,
   username VARCHAR(100) UNIQUE,
   team JSONB
);
CREATE TABLE leaderboard (
   id SERIAL PRIMARY KEY,
   user_id INTEGER REFERENCES users(id),
   score INTEGER
);

Features Covered: Real-time data tracking; Fantasy score calculation; Live leaderboard updates; Player selection interface; NFT-based digital rewards via blockchain; Push notifications using WebSockets (can be added).

Also included are Dynamic Scoring and Rewards. Real-time performance data is processed to calculate points for each athlete based on their performance in the scoring categories. Each scoring category is assigned a percentage of the total points. The total score for each athlete is calculated by summing up the points across all categories. The score is converted into a digital reward, which may include a monetary value, blockchain-based tokens, or non-fungible tokens (NFTs). The reward is securely transferred to the user's mobile device using encryption protocols.

Also included are Interactive User Features. Users receive push notifications regarding their athletes' performances and rewards. Additional features include displaying skill challenges in the GUI and enabling users to engage in competitive scenarios. Real-time updates ensure that users stay informed throughout the event.

Also included are Advanced Scoring Algorithms. For enhanced scoring, the system uses algorithms to calculate point values based on specific criteria, such as the number of participants and predetermined reward percentages. Machine learning and artificial intelligence components analyze historical and real-time data to optimize scoring and predictions. Regarding a Method for Managing a Fantasy Sports Platform, the method involves receiving user input 610 to select athletes for a fantasy team. Real-time performance data of the selected athletes is tracked, and scores are dynamically calculated based on this data. The scores are updated continuously during the event and displayed in an interactive GUI. Also included are Dynamic Team Rankings. The system adjusts team rankings in real-time by comparing scores across all users. A real-time leaderboard displays these rankings, fostering user engagement and competition. Also included are Personalized Recommendations. Machine learning models analyze historical data, user preferences, and current event metrics to provide personalized recommendations for selecting athletes. These recommendations are displayed interactively and adjusted based on live performance data.

Also included is a System for Managing a Fantasy Sports Platform. The system comprises a data input module 625 or receiving user input 610, a data processing module for calculating scores, a score updating module for real-time updates, a display module 635 for showing scores and rankings, and a ranking module for adjusting team standings dynamically.

Also included are User Engagement Features. The data input module includes a drag-and-drop interface for selecting athletes. The display module 635 provides an interactive visualization of player performance and team comparisons. Notifications and updates keep users informed about their team's progress.

Also included are Advanced Technologies. The system leverages blockchain technology for secure reward transfers and machine learning for performance predictions. Algorithms consider event-specific factors, such as venue difficulty, to provide fair and competitive scoring. Also included are Live Fantasy Sports Games. The system facilitates dynamic, live fantasy sports games. A player performance monitoring module tracks real-time metrics, while a scoring algorithm module 630 calculates and adjusts scores in real-time. A user engagement module delivers notifications about team rankings and performance updates.

Also included is Real-Time Data Processing. During a live football game, the system collects player statistics, such as passing yards and touchdowns, via a networked database 640. These metrics are processed to calculate fantasy scores, which are displayed to users in real-time. Also included are Digital Rewards. A user whose team scores the highest points in a fantasy league receives an NFT reward. The system securely transfers the NFT to the user's mobile wallet using blockchain technology. Also included are Interactive Leaderboards. A leaderboard displays the rankings of all participants in a fantasy league. Users can view detailed comparisons of their team's performance against others. Also included is Personalized Advice. Before a golf tournament, the system recommends players for a user's fantasy team based on their past performances and preferences. During the event, the recommendations are updated based on live data.

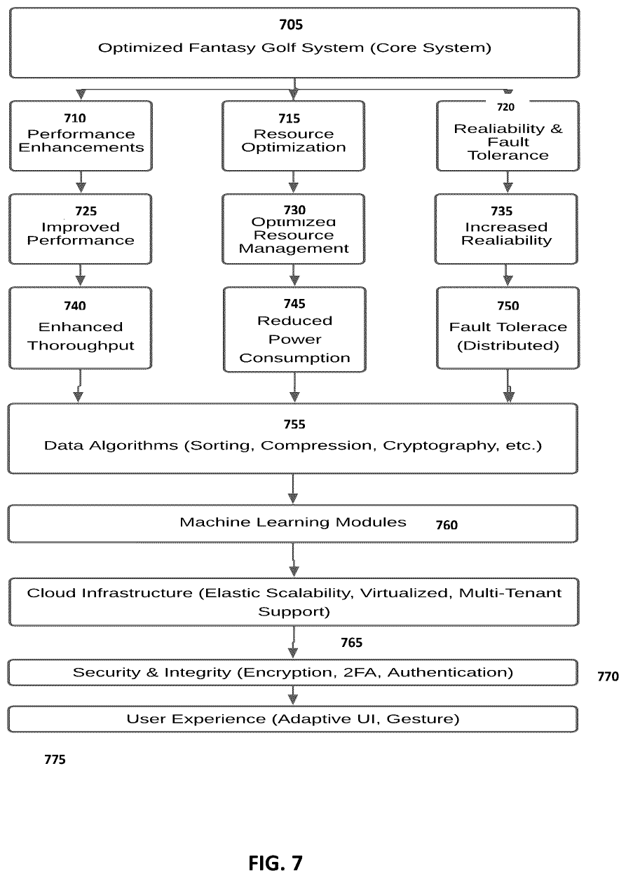

FIG. 7 illustrates how the Fantasy Golf System 705 has a technical effect on the underlying hardware and/or system. The present invention has improved performance, security, data handling, and processing and transforming data. Data is processed, manipulated, and/or interpreted to improve user interaction with the software and/or system. The user interface (UI) 615 and user experience (UX) presents information, handles input, and responds to user actions. when the software uses machine learning (ML) and/or artificial intelligence (AI), improves its functionality through learning from data, adjusting decisions, and/or automatically optimizing behavior over time. When the software utilizes cloud-based infrastructure, platforms, or services, the present invention leverages cloud computing resources to improve scalability, availability, and resource management. Security is a key area of the present invention by encrypting all transactions, protecting data, and securing all communications that safeguard data and maintain privacy. Software optimizes a system's performance, resource usage, or other factors. Optimization techniques include methods for data transmission and communication between devices, which improves network efficiency, security, and data integrity. When the software involves virtualization technologies (e.g., virtual machines, containers), it improves resource management, isolation, and scalability in virtual environments. The present invention also improves database 640 operations, such as data storage, retrieval, and management processes. The present invention creates more secure data access, consistency, and scalability. The present invention also involves distributed systems (multiple interconnected systems that work together), that improves the coordination, synchronization, and fault tolerance of distributed operations. When blockchain technology is used, it enhances the security, transparency, and scalability of decentralized systems, and involves consensus mechanisms and/or smart contract implementations. The present invention also involves integration with other systems, services, or platforms. It improves system interoperability and enhances data exchange between different software or hardware systems. The software automates tasks or decision-making processes that would otherwise require manual intervention, showcasing efficiency gains and error reduction.

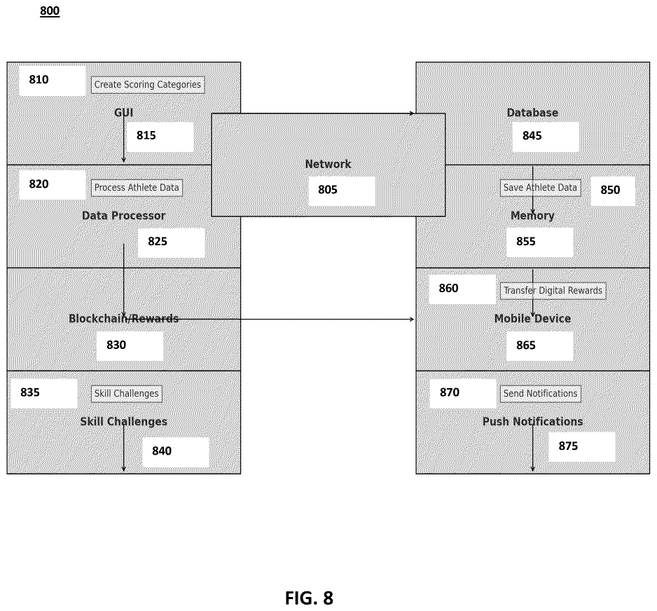

FIG. 8 is describes a method that virtualizes a fantasy sports system. It begins by creating a plurality of scoring categories associated with a sporting event. The system displays a Graphical User Interface (GUI) that allows users to choose athletes participating in the sporting event and view real-time athlete statistical data. A database 845 query retrieves real-time data, which is saved in memory. This data is then processed to calculate points based on predefined scoring categories and assigned percentages. The system calculates total points, converts them into digital rewards, and securely transfers the rewards to a mobile device.

Regarding the Scoring Categories and GUI Interaction, the method first creates multiple scoring categories, such as goals scored, assists, or rebounds, for a sporting event. These categories are displayed in a GUI that allows users to select athletes and view real-time statistics. The GUI is intuitive and provides options for selecting skill challenges. Regarding Real-Time Data Collection and Processing, Real-time athlete performance data is collected via database queries over a network. This data is stored in memory and continuously updated during the sporting event. A data processor calculates the performance of athletes based on the scoring categories and assigned point percentages.

Regarding Reward Conversion and Transfer, the calculated points are converted into digital rewards, which may include cryptocurrency, Non-Fungible Tokens (NFTs), or other digital assets. These rewards are transferred to a mobile device via a secure protocol. The method includes optional blockchain integration for enhanced security and transparency. Regarding Notifications 870 and Additional Features, push notifications 875 are sent to the user's mobile device 865, informing them of the athlete's performance and rewards earned. The system supports real-time updates and features skill challenges 840 displayed on the GUI. Data can also be shared with other viewer devices via network communication protocols.

Regarding Advanced Scoring Mechanism, For skill challenges 840, the system calculates points using a series of steps: determining the main challenge total, the number of participants, and the points-per-participant ratio. These values are further divided and multiplied to allocate rewards proportional to scoring categories. The method supports real-time execution and utilizes machine learning or AI to optimize scoring.

To implement this invention, the system employs a backend architecture comprising a database 640, memory storage 855, and a data processor 825. The GUI is developed using standard programming languages, such as HTML, JavaScript, or similar, and communicates with the backend via RESTful APIs or WebSocket protocols. Real-time athlete data 820 is sourced from reliable data providers using APIs. The blockchain module 830 utilizes Ethereum or similar platforms to facilitate the transfer of digital rewards 860. Push notifications 875 are implemented using Firebase Cloud Messaging or equivalent services. Machine learning algorithms are trained on historical performance data to provide skill challenge 835 insights and optimize point calculations. The modular architecture and advanced technologies ensure scalability and adaptability for various fantasy sports platforms.

While the invention has been described in connection with a number of embodiments and implementations, the invention is not so limited but covers various apparent modifications and equivalent arrangements, which fall within the purview of the appended claims. Although features of the invention are expressed in certain combinations among the claims, it is contemplated that these features can be arranged in any combination and order. The invention has been described herein using specific embodiments for illustrative purposes only. It will be readily apparent to one of ordinary skill in the art, however, that the principles of the invention can be embodied in other ways. Therefore, the invention should not be regarded as limited in scope to the specific embodiments disclosed herein; it should be fully commensurate in scope with the following claims.

We claim:

1. A computer-implemented method of virtualizing a fantasy sports system, the method comprising the steps of:
creating a plurality of scoring categories and associating the plurality of scoring categories with a sporting event;
assigning a percentage of points to each of the plurality of scoring categories associated with the sporting event;
selecting athletes participating in the sporting event and creating an athlete pool for a user to select an individual athlete from;
collecting real-time athlete statistical data corresponding to the selected athletes participating in the sporting event from a database query on a network;
displaying a Graphical User Interface (GUI) for choosing the individual athlete participating in the sporting event and presenting the real-time athlete statistical data;
saving in real-time to a memory the individual athlete's performance data in the sporting event;
processing from a data processor, the individual athlete's performance data corresponding to the plurality of scoring categories associated with the sporting event into points associated with the assigned percentage of points;
calculating the total amount of points associated with the individual athlete's performance data;
totaling the number of points corresponding to each individual athlete's performance data;
converting the total amount of points associated with each individual athlete's performance data into a digital reward; and
transferring the digital reward to a mobile device via a security protocol.

2. The method of claim 1, further comprising the step of sending a push notification including an athlete's performance data in the sporting event, over a network communication protocol to the mobile device.

3. The method of claim 1, wherein the step of transferring the digital reward to the mobile device includes transferring via a blockchain technology.

4. The method of claim 1, wherein the step of transferring the digital reward to the mobile device includes transferring a Non-Fungible Token.

5. The method of claim 1, wherein the step of transferring the digital reward to the mobile device includes transferring automatically.

6. The method of claim 1, further comprising the step of displaying a plurality of skill challenges on the GUI.

7. The method of claim 1, further comprising the step of creating a scoring rule for the sporting event, including the steps of:
creating a point value that corresponds to the plurality of scoring categories associated with the sporting event;
setting the point value according to a predetermined input value;
calculating an athlete's point values according to the set point value, wherein the step of calculating includes the steps of:
determining a main skill challenge point total,
determining a maximum number of participants,
determining a maximum number of points and dividing the maximum number of points by the number of participants, thereby creating a point per participant ratio based on the number of participants,
multiplying the number of points per participant with the number of participants to achieve a total amount of available points,
dividing the total available points by a predetermined percentage of rewards, and
dividing the divided total available points with each scoring category, thereby creating a points per scoring category percentage.

8. The method of claim 7, wherein the steps are carried out in real-time during the sporting event.

9. The method of claim 7, comprising a local program product utilizing machine learning, AI learning, or a combination thereof.

10. The method of claim 7, further comprising the step of sharing real-time athlete statistical data with a plurality of viewer devices connected via a network communication protocol.

11. A method for managing a fantasy sports platform using a computing system, comprising the steps of:
(a) receiving, by the computing system, user input, selecting a set of athletes for a fantasy sports team from a plurality of athletes participating in a real-world sporting event;
(b) tracking, by the computing system, real-time performance data of the selected athletes during the real-world sporting event;
(c) dynamically calculating, by the computing system, fantasy scores for each user's fantasy sports team based on the real-time performance data;
(d) updating, by the computing system, the fantasy scores of each user's team based on the performance data in real-time throughout the duration of the real-world sporting event;
(e) displaying, by the computing system, the updated fantasy scores to the user in a graphical interface;
(f) adjusting, by the computing system, the fantasy sports team's ranking dynamically based on the real-time performance data of the selected athletes and comparing the calculated fantasy scores of all users on the platform to determine a winner based on the highest fantasy score; and
(g) storing instructions on a non-transitory computer-readable medium that when executed by the computing system causes the computing system to perform the steps of (a)-(f).

12. The method of claim 11, further comprising the step of generating, by the computing system, a real-time leaderboard showing the rankings of all participating users based on the calculated fantasy scores.

13. The method of claim 11, further comprising the step of providing personalized fantasy sports guidance to a user, including: a) analyzing, by the computing system, historical performance data of the plurality of athletes; b) generating, by the computing system, a personalized set of recommended athletes for the user's fantasy team based on their historical performances, past performance in previous fantasy games, and predicted performance for an upcoming real-world sporting event; c) displaying, by the computing system, the recommended set of athletes to the user via an interactive interface.

14. The method of claim 13, wherein the recommended set of athletes is adjusted in real-time based on the athletes' live performance data during the ongoing real-world sporting event.

15. A system for managing a fantasy sports platform, comprising:
(a) a data input module configured to receive user input identifying a set of athletes for a fantasy sports team from a plurality of athletes participating in a real-world sporting event;
(b) a data processing module configured to track real-time performance data of the identified athletes during the real-world sporting event and dynamically calculate fantasy scores for each user's team based on the real-time performance data;
(c) a score updating module configured to update the fantasy scores of each user's team in real-time throughout the sporting event based on the tracked performance data;
(d) a display module configured to display the updated fantasy scores to a user via a graphical interface; and
(e) a ranking module configured to adjust the user's team ranking dynamically based on the real-time performance data and the calculated fantasy scores.

16. The system of claim 15, wherein the data input module further comprises a user interface component configured to allow the user to drag and drop athletes into a fantasy team selection area, where the user's selections are tracked by the system.

17. The system of claim 15, wherein the display module is further configured to provide a dynamic, interactive display showing player performance data and comparison between fantasy teams in real-time.

18. The system of claim 15, wherein the data processing module includes a machine learning component that analyzes historical player performance data and predicts future performance trends to assist users in making fantasy team selections.

19. The system of claim 15, wherein the ranking module further adjusts rankings based on a tournament-specific scoring algorithm that incorporates the difficulty of venue and other contextual event factors.

20. The system of claim 15, further comprising the steps of:
facilitating a dynamic, live fantasy sports game based on real-time athlete data, comprising:
a) an athlete's performance data monitoring module configured to track performance metrics of athletes during a real-world event;
b) a scoring algorithm module configured to dynamically calculate and adjust fantasy scores in real-time based on monitored athlete performance metrics; and
c) a user engagement module configured to provide real-time notifications to users regarding changes to their fantasy team's ranking and performance in relation to other participants in the game.
